(19) United States
(12) Patent Application Publication
(10) Pub. No.: US 2006/0049023 A1
(43) Pub. Date: Mar. 9, 2006

(54) Rotary conveyor belt cleaner

(76) Inventors: Phillip E. Dietsch, Galva, IL (US); Pablo F. Perez, Kewanee, IL (US); Andrew J. Waters, Kewanee, IL (US)

Correspondence Address: BARNES & THORNBURG, LLP, P.O. BOX 2786, CHICAGO, IL, 60690-2786, US

(21) Appl. No.: 10/938,776

(22) Filed: Sep. 9, 2004

(51) Int. Cl. B65G 45/00; B65G 45/16

(52) U.S. Cl. 198/499

(57) ABSTRACT

A conveyor belt cleaner including a biasing mechanism and a scraping member removably attached to the biasing mechanism. The biasing mechanism includes an inner coupler member having a base and a plurality of inner fins extending outwardly from the base. An outer coupler member includes a peripheral wall that extends around the inner coupler member. A plurality of outer fins extend inwardly from the peripheral wall of the outer coupler member with each outer fin being located between a pair of adjacent inner fins such that a cell is respectively formed between each adjacent inner fin and outer fin. A biasing member formed from a resilient elastomeric material is located between the inner and outer coupler members and includes a one or more first lobes and one or more second lobes. The first and second lobes are located alternately with respect to one another with each lobe being located in a respective cell. The inner fins and outer fins place the first lobes of the biasing member in compression, and place of the second lobes of the biasing member in tension, as the outer coupler member rotates with respect to the inner coupler member from a first position toward a second position, such that the first and second lobes resiliently bias the outer coupler member and the scraping member from the second position toward the first position.

### BACKGROUND

The present disclosure is directed to a conveyor belt cleaner including a rotational biasing mechanism and a scraper blade removably attached to the biasing mechanism, wherein the biasing mechanism includes an inner coupler member having a plurality of outwardly extending fins, an outer coupler member located concentrically about the inner coupler member and including a plurality of inwardly extending fins, and a biasing member formed from a resilient elastomeric material disposed between the inner coupler member and the outer coupler member.

Conveyor belt cleaners include one or more scraper blades that are adapted to scrape adherent material from a moving conveyor belt. The scraper blades are often either linearly or rotationally biased into scraping engagement with the conveyor belt such that the scraper blades engage the conveyor belt with a desired amount of scraping pressure and force, and such that the scraper blades maintain contact with the conveyor belt as the blades wear. When scraper blades are rotationally biased into engagement with a conveyor belt in a first rotational direction, it is also desirable for the scraper blades to be capable of rotating in an opposite second rotational direction in case the direction of movement of the conveyor belt is reversed whereby the conveyor belt may force the scraper blades to rotate in the second rotational direction. It is also desirable for the scraper blades to be movable relative to one another in a direction generally transverse to the rotational axis of the scraper blades such that the scraper blades may respectively position themselves to take into account variations in the configuration of the surface of the conveyor belt.

### SUMMARY

A conveyor belt cleaner including a support member having a central axis, one or more biasing mechanisms coupled to and supported by the support member, and one or more scraping members removably attached to each biasing mechanism. The biasing mechanism includes an inner coupler member having a longitudinal axis, a base that extends around the support member and a plurality of inner fins extending outwardly from the base. The biasing mechanism also includes an outer coupler member located concentrically about the inner coupler member. The outer coupler member includes a peripheral wall extending around the inner coupler member and a plurality of outer fins extending inwardly from the peripheral wall. Each outer fin of the outer coupler member is located between a pair of adjacent inner fins of the inner coupler member, such that a cell is respectively formed between each adjacent inner fin and outer fin. The biasing mechanism includes a biasing member formed from a resilient elastomeric material that includes one or more first lobes and one or more second lobes. The first and second lobes are located alternately with respect to one another, with each lobe located in a respective cell.

The scraping member is removably mounted on the outer coupler member of the biasing mechanism such that that outer coupler member and the scraping member are conjointly rotatable about the longitudinal axis of the inner coupler member with respect to the inner coupler member between a first position and a second position. The inner fins and the outer fins place the first lobes of the biasing member in compression, and place the second lobes of the biasing member in tension, as the outer coupler member and scraping member rotate with respect to the inner coupler member from the first position toward the second position, such that the first and second lobes are adapted to resiliently bias the outer coupler member and scraping member from the second position toward the first position. The scraping member includes a blade holder having an arm and a mounting member adapted to receive a post extending outwardly from the outer coupler member of the biasing mechanism such that the scraping member is conjointly rotatable with the outer coupler member. The scraping member also includes a scraper blade adapted to engage the conveyor belt. The mounting member of the blade holder comprises a generally C-shaped sleeve having opposing flexible legs which allow the scraping member to be snap-fit on the outer coupler member while being conjointly rotatable with the outer coupler member.

### BRIEF DESCRIPTION OF THE DRAWING FIGURES

FIG. 1 is a perspective view of the conveyor belt cleaner.

FIG. 2 is a side elevational view of the conveyor belt cleaner shown in engagement with a conveyor belt.

FIG. 3 is a top plan view of the conveyor belt cleaner.

FIG. 4 is a side elevational view of the conveyor belt cleaner.

FIG. 5 is a cross sectional view taken along line 5-5 of FIG. 3.

FIG. 6 is an exploded view of the biasing mechanism and scraping member.

FIG. 7 is a partially exploded perspective view showing the support member and a plurality of inner coupler members of the biasing mechanisms.

FIG. 8 is a perspective view of another embodiment of the biasing mechanism.

FIG. 9 is a perspective view of a further embodiment of the biasing mechanism.

FIG. 10 is a perspective view of a modified embodiment of the conveyor belt cleaner.

FIG. 11 is a side elevational view of the conveyor belt cleaner of FIG. 10.

FIG. 12 is a side elevational view of the scraping member of the conveyor belt cleaner of FIG. 10.

### DETAILED DESCRIPTION

As shown in the drawing figures the conveyor belt cleaner 20 is adapted for use in scraping adherent material from a conveyor belt 22. The conveyor belt 22 includes an interior surface 24 and an exterior load-carrying surface 26. The conveyor belt cleaner 20 includes an elongate support member 28, one or more biasing mechanisms 30 coupled to and supported by the support member 28, and one or more scraping members 32 removably attached to each biasing mechanism 30.

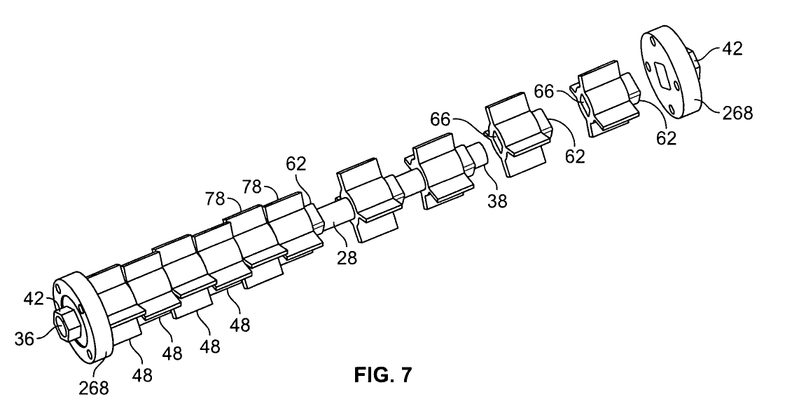

As shown in FIGS. 2 and 7, the elongate support member 28 extends between a first end 36 and a second end 38 and includes a central longitudinal axis 40. The support member 28 as shown in the drawing figures is generally cylindrical, but may be formed in other cross-sectional shapes such as square, rectangular or other polygonal configurations. The first and second ends 36 and 38 may be threaded such that each end 36 and 38 is adapted to removably receive a respective retainer member 42, for example, a threaded fastener such as a bolt. The support member 28 may be formed from various types of metal.

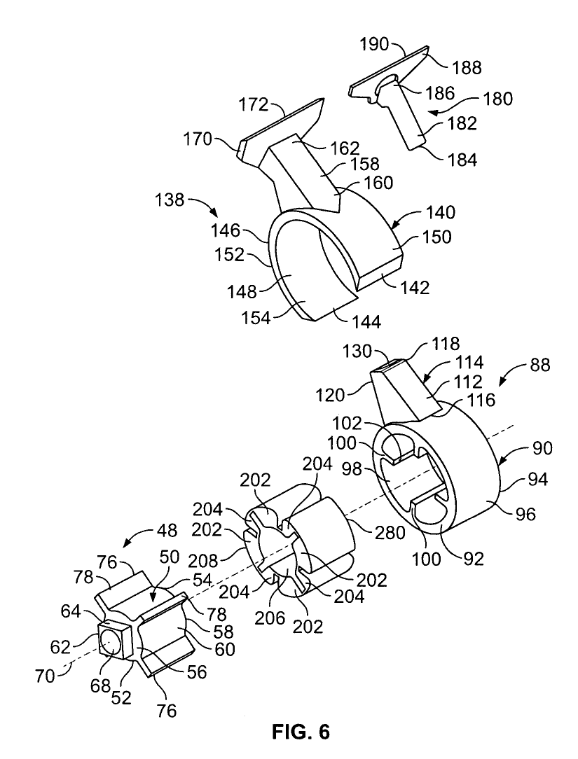

The biasing mechanism 30 includes an inner coupler member 48, such as a ring, having a base 50 that extends from a first end 52 to a second end 54. The base 50 includes a generally planar end wall 56 at the first end 52 and a spaced apart and generally parallel planar end wall 58 located at the second end 54. The base 50 also includes a generally cylindrical outer surface 60 extending between the end walls 56 and 58. If desired the outer surface 60 of the base 50 may be formed in other cross-sectional configurations, such as square or other polygonal shapes. As shown in FIG. 6, a connector member 62 extends outwardly generally perpendicularly from the end wall 56. The connector member 62 is generally rectangular and includes a plurality of generally planar side surfaces 64. The connector member 62 may be formed in other cross-sectional shapes if desired. As shown in FIG. 4, the base 50 includes a receptacle 66 that extends inwardly from the end wall 58 and that forms a hollow chamber. The receptacle 66 is generally rectangular and includes a plurality of generally planar side surfaces that form the hollow chamber. A generally cylindrical bore 68 extends linearly through the base 50 from the connector member 62 to the receptacle 66 and through the end walls 56 and 58. The bore 68 is adapted to closely receive the support member 28 such that the inner coupler member 48 is slidable along the support member 28 and along the longitudinal axis 40. The bore 68 includes a linear central longitudinal axis 70. The outer surface 60 of the base 50 extends generally concentrically about the axis 70. The receptacle 66 is adapted to matingly receive a connector member 62 from an adjacent inner coupler member 48 such that the inner coupler members are coupled together for conjoint rotation about the axis 70.

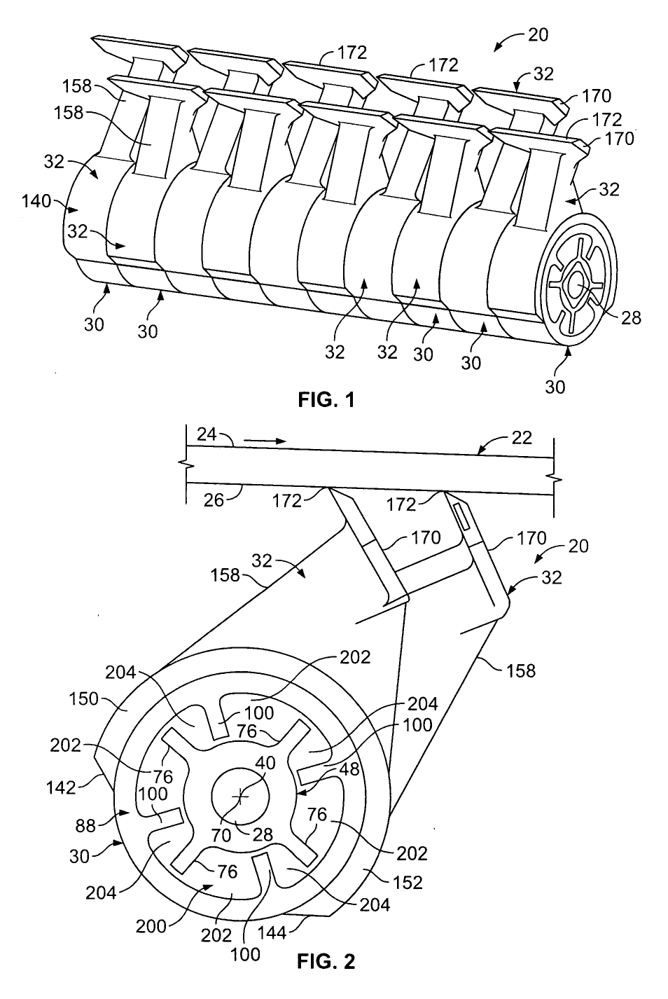

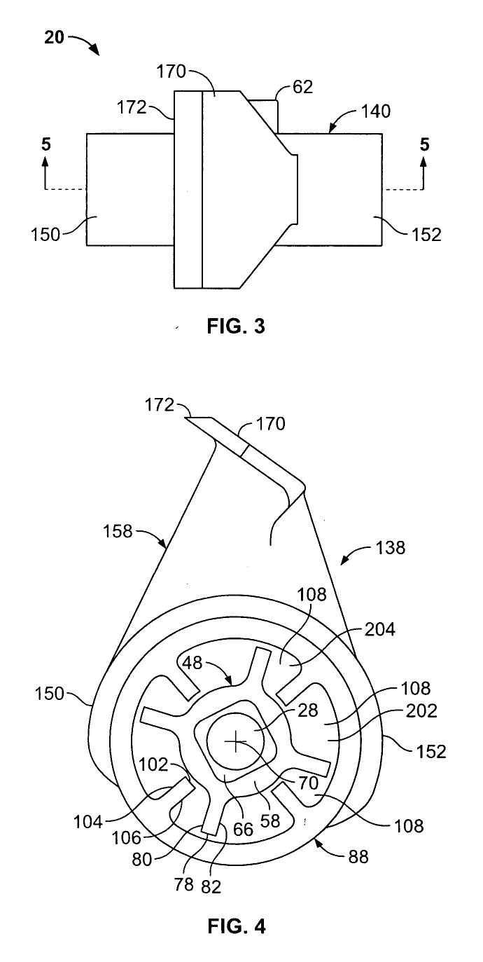

The inner coupler member 48 also includes a plurality of inner fins 76 extending generally radially outwardly from the outer surface 60 of the base 50 with respect to the axis 70. Each inner fin 76 includes a bottom end attached to the outer surface 60 of the base 50 and an elongate generally linear tip 78 located radially outwardly from the outer surface 60 of the base 50 and generally parallel to the axis 70. Each inner fin 76 includes a generally planar first surface 80 and a spaced apart and generally parallel planar second surface 82. Each surface 80 and 82 extends from adjacent the outer surface 60 of the base 50 to the tip 78. Each inner fin 76 extends between the end walls 56 and 58 of the base 50 generally parallel to the axis 70. The inner fins 76 are generally uniformly and equally spaced apart from one another about the outer surface 60 of the base 50 such that the inner fins 76 are generally symmetrically located about the axis 70. As shown in FIGS. 1-7, the inner coupler member 48 includes four inner fins 76. However, the inner coupler member 48 may include two inner fins, three inner fins, or more than four inner fins. If desired each inner fin 76 may include one or more apertures extending between the first surface 80 and the second surface 82. The inner coupler member 48 may be formed from a material such as metal or a relatively rigid plastic or elastomeric material.

The biasing mechanism 30 also includes an outer coupler member 88, such as a ring, having an annular cylindrical peripheral wall 90 that extends between a first end 92 and a second end 94. The peripheral wall 90 includes a generally cylindrical outer surface 96 and a spaced apart generally cylindrical inner surface 98. The surfaces 96 and 98 extend between the first and second ends 92 and 94. The peripheral wall 90 is located generally concentrically about the inner coupler member 48 and the axis 70 such that the base 50 and the inner fins 76 of the inner coupler member 48 are located within the peripheral wall 90. The connector member 6-vof the base 50 projects outwardly beyond the first end 92 of the peripheral wall 90 along the axis 70. The end wall 56 of the base 50 is generally coplanar with the first end 92 of the peripheral wall 90 and the end wall 58 of the base 50 is generally coplanar with the second end 94 of the peripheral wall 90.

The outer coupler member 88 includes a plurality of outer fins 100. Each outer fin 100 extends from a bottom end attached to the inner surface 98 of the peripheral wall 90 to a tip 102. Each outer fin 100 includes a generally planar first surface 104 and a spaced apart and generally parallel planar second surface 106. If desired, each outer fin 100 may include one or more apertures extending between the surfaces 104 and 106. Each outer fin 100 extends from its bottom end to the tip 102 generally radially inwardly from the inner surface 98 of the peripheral wall 90 toward the longitudinal axis 70. The tip 102 is generally linear and extends generally parallel to the axis 70. Each outer fin 100 extends between the first end 92 and the second end 94 of the peripheral wall 90 generally parallel to the axis 70. The tips 78 of the inner fins 76 are spaced apart from the inner surface 98 of the outer coupler member 88, and the tips 102 of the outer fins 100 are spaced apart from the outer surface 60 of the inner coupler member 48. The outer fins 100 are generally uniformly spaced apart from one another and are generally symmetrically located about the inner surface 98 and about the axis 70. Each outer fin 100 is located between a pair of adjacent inner fins 76. A cell 108 is respectively formed between each adjacent inner fin 76 and outer fin 100, and between the base 50 of the inner coupler member 48 and the peripheral wall 90 of the outer coupler member 88.

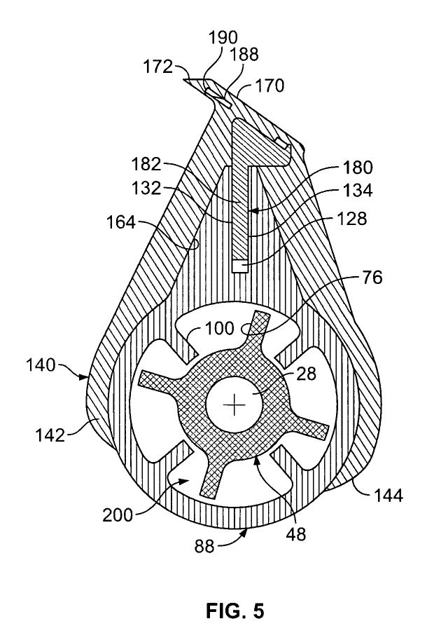

As shown in FIGS. 4 and 5, each inner fin 76 is located between an adjacent pair of outer fins 100, with one outer fin 100 being located clockwise with respect to the inner fin 76 and one outer fin 100 being located counter-clockwise with respect to the inner fin 76. The inner fin 76 is located more closely to the adjacent outer fin 100 that is located immediately clockwise to the inner fin 76 than the inner fin 76 is located with respect to the adjacent outer fin 100 that is located immediately counter-clockwise to the inner fin 76. Thus the cell 108 that is formed between the inner fin 76 and the immediately adjacent clockwise outer fin 100 is smaller in volume and has a shorter length as measured between the adjacent fins 76 and 100, than that of the cell 108 that is formed between the inner fin 76 and the outer fin 100 that is located immediately adjacent in the counter-clockwise direction. The relative location of each inner fin 76 between the adjacent pairs of outer fins 100 may be selected as desired to vary the size of the adjacent cells 108.

The outer coupler member 88 also includes a post 114. The post 114 includes a base 116 attached to the outer surface 96 of the peripheral wall 90 and extends generally radially outwardly to a distal end 118. The post 114 includes an inclined generally planar first wall 120 and an inclined generally planar second wall 122. The walls 120 and 122 extend generally parallel to the axis 70 and are arranged in a generally inverted V-shaped arrangement such that the walls 120 and 122 converge toward one another as they extend from the base 116 toward the distal end 118. The post 114 also includes a generally planar side wall 124 and a generally planar side wall 126 that are spaced apart and parallel to one another. The side walls 124 and 126 are generally perpendicular to the axis 70 and to the first and second walls 120 and 122. The side walls 124 and 126 extend between the first wall 120 and second wall 122. The post 114 includes a hollow receptacle 128 in communication with an aperture 130 in the distal end 118 of the post 114. The receptacle 128 has a generally rectangular cross section formed by a generally planar internal wall 132 that is spaced apart from and generally parallel to a generally planar internal wall 134. The receptacle 128 extends inwardly into the post 114 from the aperture 130 to a bottom wall located adjacent the base 116. The outer coupler member 88 may be formed from a material such as metal or a rigid plastic or elastomeric material.

The biasing mechanism 30 also includes a resilient biasing member 200 located between the inner coupler member 48 and outer coupler member 88 concentrically about the inner coupler member 48 and axis 70. The biasing member 200 includes a plurality of first lobes 202 and a plurality of second lobes 204. The lobes 202 and 204 are located in a circular manner about a central bore 206 that extends from a first end 208 to a second end 210 of the biasing member 200. The first lobes 202 and second lobes 204 are located alternately with respect to the one another about the bore 206 and axis 70. Each lobe 202 and 204 includes an end wall that is in engagement with and attached to an inner fin 76 of the inner coupler member 48 and an opposing end wall that is in engagement with and attached to an outer fin 100 of the outer coupler member 88. Each lobe 202 and 204 also includes an inner surface that is in engagement with the outer surface 60 of the inner coupler member 48 and an outer surface that is in engagement with the inner surface 98 of the outer coupler member 88. Each cell 108 formed between the inner coupler member 48 and outer coupler member 88 is respectively filled with a lobe 202 or 204 of the biasing member 200. The lobes 202 and 204 are connected to one another such that the biasing member 200 is formed as an integral one-piece member. The biasing member 200 may be molded in place between the inner coupler member 48 and outer coupler member 88.

The biasing member 200 may be formed from a resilient elastomeric material. A resilient elastomeric material from which the biasing member 200 may be formed is disclosed in U.S. Pat. No. 5,798,411, issued Aug. 25, 1998, for Compressible Polyurethane Compositions Having Minimal Tack and Articles Therefrom, which is incorporated herein by reference. This resilient elastomeric material is formed from a polyurethane composition which may comprise 140 parts by weight of a polyol, wherein polyols include diols, from about 50 to 70 parts by weight of a diisocyanate compound, the polyols, diols and diisocyanate compounds being selected from the group consisting of reactants capable of forming polyurethanes, from about one to about thirty percent by weight of a plasticizer based upon the weight of the polyurethane composition, and from about 0 to about 100 parts by weight of a mineral filler, based upon 100 parts by weight of the polyurethane composition. The plasticizer may comprise mineral oil. The mineral filler may be selected from the group consisting of calcium carbonate and clays. This biasing material is available from The Hygenic Corporation of Akron, Ohio, which is the assignee of U.S. Pat. No. 5,798,411.

One composition of the resilient biasing material that is available from The Hygenic Corporation as formulation reference number WO3301 comprises 140 parts by weight polyol, 62.5 parts by weight diisocyanate, and 13 parts by weight mineral oil. A two inch diameter ball of this resilient material can be compressed to one inch with the application of seventeen pounds of force. A two inch diameter ball of this material can be compressed to less than forty percent of its diameter. A two inch diameter ball of this material takes about twenty seconds to recover from a fifty percent compression. Another composition of the resilient biasing material that is available from The Hygenic Corporation comprises 140 parts by weight polyol, 60 parts by weight diisocyanate, and 7 parts by weight mineral oil. A two inch diameter ball of this resilient material can be compressed to one inch with the application of eight pounds of force.

This resilient biasing material will not take a set when deformed by compression under a load and resiliently returns to its original shape when the load is removed. The resilient material has a retarded resilience in that its rate of recovery after deformation by compression is gradual and not rapid. The biasing force generated by the return of the biasing material to its original configuration is not sufficient to cause the scraping member 32 to resonate in engagement with the conveyor belt 22. The composition of the resilient material that forms the biasing member 200 may be varied depending on the scraping application with which the biasing mechanism 30 will be used to make the biasing member 200 stiffer or softer as may be needed while retaining retarded resilience. The fluid-like nature of the biasing member 200 in its ability to deform allows the outer coupler member 88 and the scraping member 32 to move vertically and/or horizontally and to pivot in any direction from a center of rotation. The biasing member 200 provides a floating pivot point such that the scraping member 32 is able to pivot in multiple directions about the pivot point and to move vertically and/or horizontally.

The scraping member 32 includes a blade holder 138 having a generally C-shaped mounting member 140 that extends in a generally circular manner from a first end 142 to a second end 144. The mounting member 140 includes a sleeve 146 that extends in a generally circular manner from the first end 142 to the second end 144 and that includes a generally cylindrical-shaped inner wall 148. The sleeve 146 includes a resiliently flexible first leg 150 that extends to and includes the first end 142 and a resiliently flexible second leg 152 that extends to and includes the second end 144 of the mounting member 140. The first and second legs 150 and 152 are located on opposite sides of a hollow seat 154 formed within the sleeve 146. A slot in communication with the seat 154 is located between the ends 142 and 144 of the legs 150 and 152. The legs 150 and 152 are resiliently flexible such that the ends 142 and 144 may be resiliently flexed apart from one another to increase the width of the slot opening therebetween.

The blade holder 138 also includes an arm 158 having a first end 160 and a second end 162. The first end 160 of the arm 158 is attached to the exterior surface of the sleeve 146. The first leg 150 of the mounting member 140 extends from adjacent the arm 158 to the first end 142 of the mounting member 140, and the second leg 152 extends from the arm 158 to the second end 144 of the mounting member 140. The second end 162 of the arm 158 is located radially outwardly from the sleeve 146. The arm 158 includes a recess 164 that is in communication with the seat 154 and that is adapted to matingly receive the post 114 of the outer coupler member 88 as shown in FIG. 5. The blade holder 138 also includes a scraping blade 170 attached to the second end 162 of the arm 158. The scraping blade 170 includes a generally linear scraping edge 172 adapted to engage the conveyor belt 22. The scraping blade 170 may be disposed in an aggressive peeling angle of attack with respect to the conveyor belt 22 wherein the blade opposes the direction of travel of the belt, or in a passive scraping angle of attack wherein the blade is inclined in the direction of belt travel. The blade holder 138 may be formed from a resilient elastomeric material such as urethane. The elastomeric material may have a durometer of approximately 70 Shore A to approximately 70 Shore D.

The scraping member 32 also includes a blade insert member 180. The blade insert member 180 includes a tongue 182 having a first end 184 and a second end 186. The blade insert member 180 also includes a blade insert 188 attached to a second end 186 of the tongue 182. The blade insert 188 is generally plate-like and includes a generally linear tip 190. The blade insert member 180 or its scraping end, may be formed from a metal material and may be formed from a wear-resistant material such as, for example, tungsten carbide, stainless steel, or ceramic materials. The blade insert 188 is adapted to be molded within and enclosed within the scraping blade 170 of the blade holder 138. The tongue 182 of the blade insert member 180 is adapted to extend inwardly into the recess 164 of the arm 158 of the blade holder 138. The tongue 182 is adapted to fit matingly within the receptacle 128 of the post 114 of the outer coupler member 88 as shown in FIG. 5.

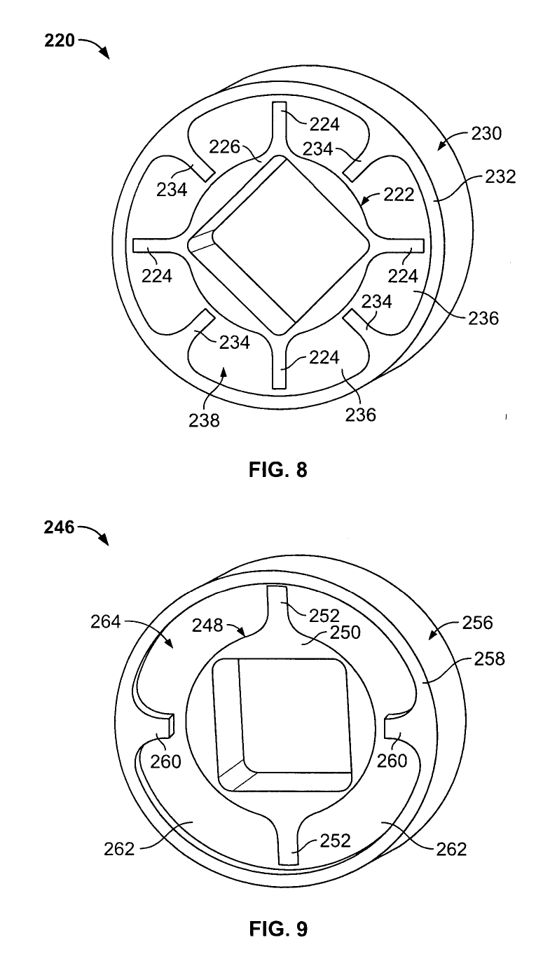

FIG. 8 shows another embodiment of the biasing mechanism referenced with the number 220. The biasing mechanism 220 includes an inner coupler member 222 having four inner fins 224 extending radially outwardly from the base of the inner coupler member 222. The inner fins 224 are uniformly spaced apart from one another about the base 226. The biasing mechanism 220 also includes an outer coupler member 230 including a peripheral wall 232 and four outer fins 234 that extend radially inwardly from the interior surface of the peripheral wall 232. The outer fins 234 are spaced uniformly apart from one another about the peripheral wall 232. As shown in FIG. 8, each inner fin 224 is located generally midway and equally between two adjacent outer fins 234. Similarly, each outer fin 234 is located generally midway and equally between two adjacent inner fins 224. A cell 236 is formed between each inner fin 224 and adjacent outer fin 234. All of the cells 236 in the biasing mechanism 220 are of approximately the same size. A resilient elastomeric biasing member 238 is located between the inner coupler member 222 and the outer coupler member 230. The biasing member 238 includes a plurality of lobes that respectively fill the cells 236. All of the lobes of the biasing member 238 are of generally uniform size.

FIG. 9 shows another embodiment of the biasing mechanism referenced with the number 246. The biasing mechanism 246 includes an inner coupler member 248 having a base 250 and two inner fins 252 extending radially outwardly from the base 250. The inner fins 252 are located generally uniformly apart from one another about the base 250 and are located generally diametrically across from one another. The biasing mechanism 256 also includes an outer coupler member 256 including a peripheral wall 258 and two outer fins 260 that extend generally radially inwardly from the peripheral wall 258. The outer fins 260 are uniformly spaced apart from one another about the peripheral wall 258 and are located generally diametrically across from one another.

Each inner fin 252 is positioned generally midway and equally between an adjacent pair of outer fins 260. Similarly, each outer fin 260 is positioned generally midway and equally between an adjacent pair of inner fins 252. A cell 262 is formed between each adjacent pair of inner fins 252 and outer fins 260. The biasing mechanism 246 also includes a resilient elastomeric biasing member 264 that is located between the inner coupler member 248 and outer coupler member 256. The biasing member 264 includes a plurality of lobes that are of generally uniform size and that are respectively located in the cells 262.

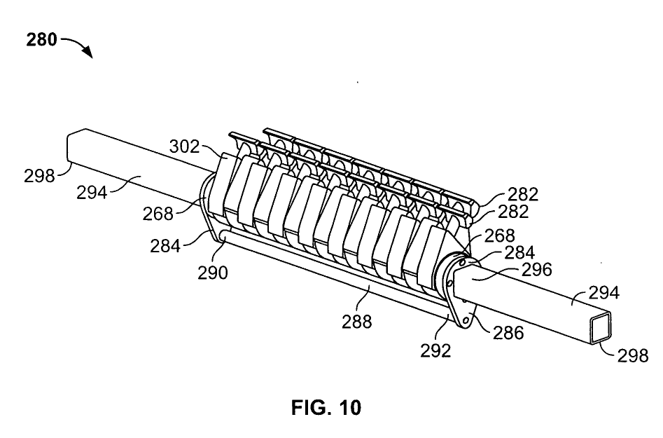

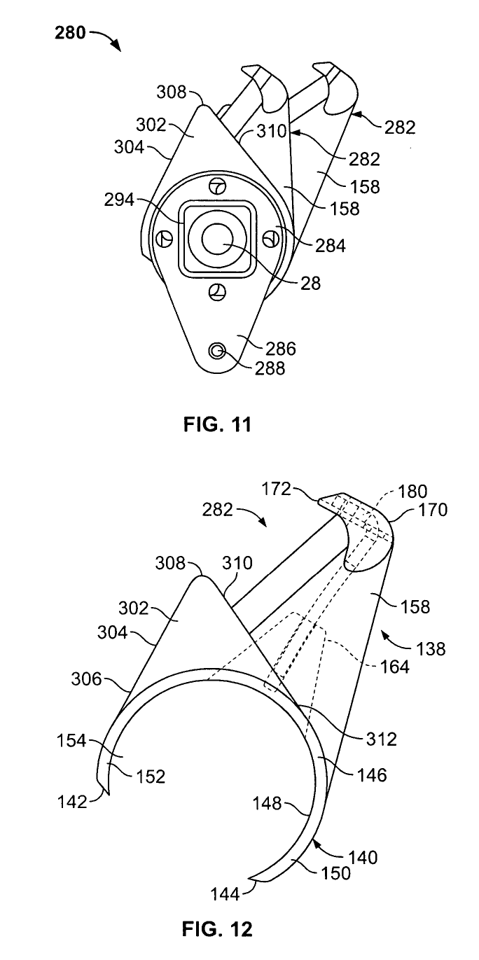

FIGS. 10-12 show a modified embodiment of the conveyor belt cleaner identified with the reference number 280. The conveyor belt cleaner 280 includes many of the same components as the conveyor belt cleaner 20 and like components are indicated with the same reference number. The conveyor belt cleaner 280 includes a support member 28. One or more biasing mechanisms 30 including an inner coupler member 48, an outer coupler member 88, and a resilient elastomeric biasing member 200 disposed between the inner coupler member 48 and outer coupler member 88, are removably mounted on the support member 28. Each end 36 and 38 of the support member 28 is attached to a respective mounting hub 268. A scraping member 282 is removably attached to each outer coupler member 88. First and second mounting brackets 284 are respectively attached to the mounting hubs 268. Each mounting bracket 284 includes a lug 268 that is located generally transversely from the central axis of the support member 28. Each lug 286 is adapted to be located generally vertically below the support member 28. A cross member 288 is attached to and extends between the lug 286 of the first mounting bracket 284 and the lug 286 of the second mounting bracket 284. The cross member 288 includes a first end 290 removably attached to the lug 286 of the first mounting bracket 284 and a second end removably attached to the lug 286 of the second mounting bracket 284. The cross member 288 includes a longitudinal central axis that is spaced apart from and generally parallel to the central axis of the support member 28. The cross member 288 may be formed as a solid or tubular shaft. The cross member 288 is adapted to strengthen and stiffen the support member 28, and limits bending of the support member 28 that may occur if the distance between the mounting hubs 268 is sufficiently large. The cross member 288 assists in ensuring that the biasing members 200, outer coupler members 88 and scraping members 282 remain properly aligned and free to move and rotate as described herein.

An extension member 294, including a first end 296 and a second end 298, is attached to each mounting bracket 284. The first ends 296 of the extension members 294 are attached to the mounting brackets 284. The extension members 294 are located generally coaxially with respect to the central axis of the support member 28. The extension members 294 are adapted to mount the conveyor belt cleaner 280 to a structure.

As shown in FIG. 12, the scraping member 282 includes many of the same components as the scraping member 32 and such components are indicated with the same reference number. The scraping member 282 includes an arm 158 attached to a mounting member 140, and a scraping blade 170 attached to the arm member 158. The scraping member 282 also includes a deflector member 302. The deflector member 302 is attached to the outer surface of the mounting member 140. The deflector member 302 is generally triangular-shaped and includes a first generally planar surface 304 that extends from a first end 306 located adjacent the second leg 152 of the mounting member 140 to a second end located at an apex 308 of the deflector member 302. The deflector member 302 also includes a generally planar second surface 310 that extends from a first end 312 that is located adjacent the first leg 150 of the mounting member 140 to a second end located at the apex 308. A portion of the arm 150 is attached to the second surface 310 of the deflector member 302. The deflector member 302 is adapted to inhibit material scraped from the conveyor belt from building up on the arm 158. The first surface 304 of the deflector member 302 forms a steep slope when the scraping member 282 is in operation that inhibits any material that is removed from the conveyor belt from building up on the front or leading edge of the arm 158. The second surface 310 forms a steep slope that assists material scraped from the conveyor belt to easily slide to the rear of the scraping member 282 and away from the arm 158. The scraping member 282 is adapted to be removably attached to the outer coupler member 88 in the same manner as the scraping member 32.

In operation, one or more biasing mechanisms 30 are slid longitudinally onto the support member 28, with the support member 28 being inserted through the bores 68 of the inner coupler members 48 such that the axes 40 and 70 are coaxial with one another. The biasing mechanisms 30 are located adjacent to one another such that the connector member 62 of an inner coupler member 48 is located within the receptacle 66 of the inner coupler member 48 of an adjacent second biasing mechanism 30. The inner coupler members 48 of the biasing mechanisms 30 are thereby attached to one another for conjoint rotation about the longitudinal axis 40 of the support member 28 and the longitudinal axis 70 of the inner coupler members 48. However, the biasing mechanisms 30 may be separated from one another by movement in a longitudinal direction along the support member 28 parallel to the axes 40 and 70. The inner coupler member 48 of the biasing mechanism 30 may be rotatable about the axes 40 and 70 with respect to the support member 28. The outer-most located biasing mechanism 30 at each end of the support member 28 is removably attached to a mounting hub 268. The support member 28 is also attached at each end to a respective mounting hub 268. The inner coupler members 48 are biased together on the support member 28 by the retainer members 42 and the mounting hubs 268. The support member 28, and a plurality of inner coupler members 48 interlocked with one another and supported on the support member 28 as shown in FIG. 7, form a support frame for a conveyor belt cleaner. As shown in FIG. 7, the inner fins 76 of the adjacent inner coupler members 76 may be rotationally offset with respect to one another in an alternating manner, with every other set of inner fins 76 of the inner coupler members 48 being located in a first position and each set of inner fins 76 of the intermediate inner coupler members 48 being located in a second rotational position. The posts 114 of the biasing mechanisms 30 will similarly be located in alternating rotationally offset positions. Alternatively, all of the inner fins 76 and posts 114 can be aligned with one another.

A scraping member 32 is removably attached to a respective biasing mechanism 30. The mounting member 140 of the blade holder 138 is placed over the post 114, such that the post 114 is inserted into the seat 154 between the first and second ends 142 and 144 of the mounting member 140. As the width of the slot between the first and second ends 142 and 144 of the mounting member 140 is narrower than the diameter of the peripheral wall 90 of the outer coupler member 88, the first and second ends 142 and 144 of the mounting member 140 will engage the outer surface 96 of the peripheral wall 90. Continued movement of the scraping member 32 toward the biasing mechanism 30 will resiliently flex the legs 150 and 152 outwardly and spread the first and second ends 142 and 144 of the mounting member 140 apart from one another, such that the first and second ends 142 and 144 of the mounting member 140 will pass over the widest part of the peripheral wall 90 and will resiliently return toward their original unbiased position once the peripheral wall 90 of the outer coupler member 88 is located within the seat 154.

When the peripheral wall 90 of the outer coupler member 88 is located within the seat 154 of the mounting member 140 of the blade holder 138, the post 114 is located matingly within the recess 164 of the arm 158 of the blade holder 138. The inner wall 148 of the sleeve 146 of the mounting member 140 closely engages the outer surface 96 of the peripheral wall 90. The sleeve 146 of the mounting member 140 extends between the first end 142 and the second end 144 about the peripheral wall 90 of the outer coupler member 88 more than one-hundred eighty degrees. The resiliently flexible legs 150 and 152 of the mounting member 140 of the blade holder 138 resiliently grip the peripheral wall 90 of the outer coupler member 88 thereby retaining the blade holder 138 in engagement with the outer coupler member 88, while allowing removal of the blade holder 138 from the outer coupler member 88 upon the application of sufficient force in a direction generally parallel to a central axis of the arm 158 of the blade holder 138 generally transverse to the axis 70. The blade holder 138 is snap-fit onto the outer coupler member 88. The post 114 couples the blade holder 135 to the outer coupler member 88 for conjoint rotation with the outer coupler member 88.

As shown in FIGS. 1 and 2, the length of each arm 158 of the blade holder 138 may be alternated between a short arm and a long arm across the width of the conveyor belt cleaner 20 such that the scraping members 32 will overlap in their scraping coverage. The scraping edge 172 of a scraping member 32 having a long arm 158 will be located further from the axis 70 than is the scraping edge 172 of a scraping member 32 having a short arm 158.

The scraping members 32 may be placed into biased scraping engagement with the exterior surface 26 of the conveyor belt 22 by moving the support member 28 and inner coupler members 48 of the biasing mechanisms 30 generally linearly toward the conveyor belt 22, or by rotating the inner coupler members 48 about the axis 70 in a generally counter-clockwise direction as viewed in FIG. 2. Once the scraping blades 170 of the scraping members 32 engage the conveyor belt 22, continued linear or rotational movement of the inner coupler member 48 of the biasing mechanism 30 will resiliently bias the scraper blades 170 into scraping engagement with the conveyor belt 22.

As the scraping blade 170 of the blade holder 138 wears due to its scraping engagement with the conveyor belt 22, the tip 190 of the blade insert 188 will come into scraping engagement with the conveyor belt 22. The material of the blade holder 138 that initially forms the scraping edge 172 of the scraping blade 170 allows the scraper blade insert 188 to wear in gradually and thereby avoid damaging the conveyor belt 22. As the scraping blade 170 and blade insert 188 wear, the biasing mechanism 30 will rotate the scraping member 32 into continuing biased engagement with the conveyor belt 22. When the scraping blade 170 is worn, the scraping member 32 can be removed from the biasing mechanism 30 and a new scraping member 32 can be attached to the biasing mechanism 30.

As viewed in FIG. 2, as the inner coupler member 48 is moved linearly closer to the conveyor belt 22, without any rotation of the inner coupler member 48, each outer fin 100 will rotate in a clockwise direction toward an adjacent inner fin 76 of the inner coupler member 48 that is located in the clockwise direction from the outer fin 100. Each first lobe 202 of the biasing member 200 is located between an inner fin 76 of the inner coupler member 48 and an outer fin 100 of the outer coupler member 88 that is located adjacent to the inner fin 76 in the counter-clockwise direction from the inner fin 76. Each first lobe 202 of the biasing member 200 is placed into compression between the inner fin 76 and outer fin 100 as the outer coupler member 88 rotates in the clockwise direction with respect to the inner coupler member 48 from a neutral unbiased position to a biased position.

When the outer coupler member 88 is rotated in the clockwise direction with respect to the inner coupler member 48, each outer fin 100 of the outer coupler member 88 rotates away from the inner fin 76 that is located adjacent to the outer fin 100 in a counter-cloc-wise direction. The second lobes 204 of the biasing mechanism 200 are located between the inner fin 76 of the inner coupler member 48 and the outer fin 100 of the outer coupler member 88 that is located adjacent to the inner fin 76 in the clockwise direction. As the outer coupler member 88 rotates from an unbiased neutral position in a clockwise direction with respect to the inner coupler member 48, the outer fins 100 place the second lobes 204 in tension. As the outer coupler member 88 rotates in the clockwise direction with respect to the inner coupler member 48, the first lobes 202 of the biasing member 200 are placed in compression and the second lobes 204 of the biasing mechanism 200 are placed in tension, such that the first lobes 202 and the second lobes 204 all resiliently bias the outer coupler member 88 and scraping member 32 in a counter-clockwise rotational direction about the axis 70 from a rotationally biased position toward a neutral unbiased position.

Each scraping blade 170 of the conveyor belt cleaner may be biased into engagement with the conveyor belt 22 with a uniform scraping force or pressure. Scraping members 32 having short arms 158 must therefore be provided with a larger rotational biasing force than are the scraping members 32 having long arms 158, in order for the short arm scraping members 32 to be biased into engagement with the conveyor belt 22 with the same force and pressure as are the scraping members 32 having long arms 158. The rotational biasing force that each biasing mechanism 30 provides for a given angle or increment of rotation of the outer coupler member 88 with respect to the inner coupler member 48 can be selectively adjusted or tuned by forming each biasing member 200 from different selected resilient elastomeric materials. For example, an elastomeric material having a first durometer of hardness may be used in connection with the long arm scraping members 32 and a elastomeric material having a different durometer of hardness may be used in connection with the long arm scraping members 32. The width and length of the fins 76 and 100 determine the cross sectional area of the lobes 202 and 204 that is placed into compression or tension. The rotational biasing force provided by the biasing member 200 in response to an incremental rotation of the outer coupler member 88 with respect to the inner coupler member 48 may be selectively adjusted or tuned by adjusting the length of the inner fins 76 from their base to their tips 78, by adjusting the length of the outer fins 100 between their base and their tips 102, by varying the width of the fins 76 and 100, and by varying the position of each outer fin 100 with respect to the pair of inner fins 76 between which the outer fin 100 is located. The length of each lobe 202 and 204 between their adjacent inner fin 76 and outer fin 100 may be adjusted to provide a selected biasing force by changing the position of the outer fins 100 with respect to the adjacent pair of inner fins 76.

The biasing mechanism 30 will also provide a clockwise rotational biasing force to the outer coupler member 88 if the outer coupler member 88 is rotated from a neutral unbiased position in a counter-clockwise direction with respect to the inner coupler member 48. In this case the first lobes 202 will be placed in tension and the second lobes 204 will be placed in compression. The biasing member 200 also allows for limited vertical and/or horizontal movement of the outer coupler member 88 and scraping member 32 with respect to the inner coupler member 48.

The force with which each scraping member 32 is biased into the engagement with conveyor belt 22 for a given increment of rotation of the outer coupler member 88 with respect to the inner coupler member 48 can be varied and tuned to provide either more biasing force or less biasing force by changing the composition of the resilient elastomeric material that forms the biasing member 200, by changing the length of the arm 158 of the scraping member 32, changing the offset angles of the long arm scraping members 32 with respect to the short arm scraping members 32, reducing or increasing the number of cells 108 in each biasing mechanism, changing the length of the cells 108 and lobes 202 and 204 between the fins 76 and 100, and/or by reducing or increasing the length of the fins 76 and 100.

While rotation of the outer coupler member 88 in the clockwise direction with respect to the inner coupler member 48 has been referred to herein, such rotation is equivalent to the inner coupler member 48 rotating in a counter-clockwise direction with respect to the outer coupler member 88 in regard to compressing and tensioning the lobes of the biasing member 200. Similarly, rotation of the inner coupler member 48 in a clockwise direction with respect to the outer coupler member 88 is equivalent to the outer coupler member 88 rotating in a counter-clockwise direction with respect to the inner coupler member 48 in regard to compressing and tensioning the lobes of the biasing member 200.

Various features of the invention have been particularly shown and described in connection with the illustrated embodiments of the invention, however, it must be understood that these particular arrangements merely illustrate, and that the invention is to be given its fullest interpretation within the terms of the appended claims.

What is claimed is:

1. A biasing mechanism for biasing a scraping blade into engagement with a conveyor belt, said biasing mechanism including:
an inner coupler member having a base, said base including a longitudinal axis, and a plurality of inner fins extending outwardly from said base;
an outer coupler member including a peripheral wall extending around said inner coupler member, and a plurality of outer fins extending inwardly from said peripheral wall, each said outer fin adapted to be positioned between a pair of adjacent inner fins such that a cell is respectively formed between each adjacent inner fin and outer fin, said outer coupler member being rotatable about said longitudinal axis with respect to said inner coupler member between a first position and a second position; and
a biasing member formed from a resilient elastomeric material, said biasing member including one or more first lobes and one or more second lobes, said first and second lobes being located alternately with respect to one another, each said lobe adapted to be located in a respective cell;
whereby said inner fins and said outer fins place said first lobes of said biasing member in compression and place said second lobes of said biasing member in tension as said outer coupler member rotates with respect to said inner coupler member from said first position toward said second position, said first and second lobes adapted to bias said outer coupler member from said second position toward said first position.

2. The biasing mechanism of claim 1 wherein each said inner fin extends outwardly from said base to a tip, said tips of said inner fins being spaced apart from said peripheral wall of said outer coupler member, and each said outer fin extends inwardly from said peripheral wall of said outer coupler member to a tip, said tips of said outer fins being spaced apart from said base of said inner coupler member.

3. The biasing mechanism of claim 1 wherein each said inner fin of said inner coupler member extends generally radially from said base of said inner coupler member, and each said outer fin of said outer coupler member extends inwardly generally radially from said peripheral wall of said outer coupler member.

4. The biasing mechanism of claim 1 wherein said inner fins of said inner coupler member are generally uniformly spaced around said base of said inner coupler member, and said outer fins of said outer coupler member are generally uniformly spaced about said peripheral wall of said outer coupler member.

5. The biasing mechanism of claim 1 wherein each said outer fin is located generally midway between an adjacent pair of inner fins when said outer coupler member is in said first position.

6. The biasing mechanism of claim 1 wherein each said outer fin of said outer coupler member is located closer to a first inner fin of a pair of adjacent inner fins than said outer fin is located with respect to a second inner fin of the pair of adjacent inner fins when said outer coupler member is in said first position.

7. The biasing mechanism of claim 6 wherein each said outer fin moves toward said second inner fin of the pair of adjacent inner fins as said outer coupler member rotates from said first position toward said second position.

8. The biasing mechanism of claim 1 wherein said first lobes and said second lobes of said biasing member are integrally connected to one another.

9. The biasing mechanism of claim 1 wherein each said inner fin and each said outer fin includes a generally planar first surface and a generally planar second surface.

10. The biasing mechanism of claim 1 wherein said base member of said inner coupler member includes a bore extending along said longitudinal axis, a first end including a connector member and a second end including a receptacle.

11. The biasing mechanism of claim 10 including a support member adapted to be inserted through said bore of said base member of said inner coupler member.

12. The biasing mechanism of claim 1 including a scraping blade adapted to be coupled to said outer coupler member for conjoint rotation with said outer coupler member.

13. The biasing mechanism of claim 12 including a scraping member, said scraping member including a blade holder and said scraping blade, said blade holder including a mounting member and an arm connecting said scraping blade to said mounting member.

14. The biasing mechanism of claim 13 wherein said mounting member of said blade holder includes a sleeve, said sleeve including a first leg having a first end, a second leg including a second end, and a seat located between said first leg and said second leg adapted to receive said peripheral wall of said outer coupler member.

15. The biasing mechanism of claim 14 wherein said sleeve is generally C-shaped.

16. The biasing mechanism of claim 14 wherein said sleeve includes a generally cylindrical-shaped inner wall extending from said first end of said first leg to said second end of said second leg, and a slot located between said first end of said first leg and said second end of said second leg.

17. The biasing mechanism of claim 16 wherein said peripheral wall of said outer coupler member is wider than the width of said slot of said sleeve, whereby said sleeve is adapted to resiliently flex such that said sleeve can be removably snap fit onto said peripheral wall of said outer coupler member.

18. The biasing mechanism of claim 14 wherein said outer coupler member includes a post extending outwardly from said peripheral wall of said outer coupler member, and said arm of said blade holder includes a recess in communication with said seat of said sleeve, said recess adapted to receive said post when said scraping member is mounted on said biasing member such that said scraping member is conjointly rotatable with said outer coupler member.

19. The biasing mechanism of claim 18 wherein said post of said outer coupler member includes a distal end including an aperture and a receptacle in communication with said aperture, and said scraping member includes an insert member, said insert member including said blade and a tongue attached to said blade, said tongue located within said recess of said blade holder such that said tongue is adapted to be inserted into said receptacle of said post when said scraping member is mounted on said biasing member, said tongue adapted to couple said blade to said outer coupler member of said biasing mechanism for conjoint rotation with said outer coupler member.

20. The biasing mechanism of claim 19 wherein said blade of said insert member is molded within a scraping blade of said blade holder.

21. The biasing mechanism of claim 19 wherein said blade holder of said scraping member is formed from an elastomeric material.

22. A scraping member for a conveyor belt cleaner adapted to be attached to a biasing mechanism, said scraping member comprising:
a mounting member including a sleeve having a slot, said sleeve including a resiliently flexible first leg having a first end and a resiliently flexible second leg having a second end, said slot being located between said first and second ends of said legs, and a seat located within said sleeve between said first and second legs;
an arm having a first end and a second end, said first end of said arm attached to said mounting member; and
a blade coupled to said second end of said arm, said blade adapted to engage a conveyor belt;
whereby said mounting member is removably attachable to the biasing mechanism by flexing said ends of said legs of said sleeve apart from one another and placing said sleeve around the biasing mechanism such that the biasing mechanism is located within said seat and such that said legs resiliently grip the biasing mechanism.

23. The scraping member of claim 22 wherein said arm includes a recess in communication with said seat, said recess adapted to receive a portion of the biasing mechanism to thereby couple said arm to the biasing mechanism for rotation by the biasing mechanism.

24. The scraping member of claim 23 including an insert member, said insert member including a tongue having a first end and a second end, said first end of said tongue being located within said recess of said arm and adapted to engage the biasing mechanism, said second end of said tongue adapted to be coupled to said blade.

25. The scraping member of claim 23 wherein said blade comprises a blade insert attached to said second end of said tongue.

26. The scraping member of claim 25 wherein said blade insert is molded within said blade.

27. The scraping member of claim 22 wherein said sleeve is generally cylindrical.

28. A support frame for a conveyor belt cleaner, said support frame comprising:
an elongate support member having a first end, a second end, and a central axis;
a plurality of coupler members adapted to be supported on said support member, each said coupler member including a first end, a second end, and a bore extending from said first end to said second end, said bore adapted to receive said support member, said first end of each said coupler member including a connector member, said second end of each said coupler member including a receptacle adapted to receive said connector member of an adjacent coupler member, each said coupler member adapted to be coupled to a scraping member of a conveyor belt cleaner.

29. The support frame of claim 28 wherein each said coupler member includes a plurality of outwardly extending fins.

30. The support frame of claim 28 wherein said support member is generally cylindrical and said bores of said coupler members are generally cylindrical.

31. The support frame of claim 28 including a first retainer member adapted to be connected to said first end of said support member, and a second retainer member adapted to be attached to said second end of said support member, said first and second retainer members adapted to retain said coupler members therebetween on said support member.

32. The support frame of claim 28 including a first mounting hub adapted to receive said first end of said support member, and a second mounting hub adapted to receive said second end of said support member, said mounting hubs adapted to connect said support member to a structure.

33. The support frame of claim 32 wherein said first mounting hub includes a recess adapted to receive said connector member of a coupler member.

34. The support frame of claim 32 including a cross member having a first end and a second end, said cross member including a first end connected to said first mounting hub and a second end connected to said second mounting hub, said support member adapted to provide support to said support member.

35. The support frame of claim 34 including a first lug attached to said first mounting hub and a second lug attached to said second mounting hub, said first end of said cross member being connected to said first lug and said second end of said cross member being connected to said second lug.
